(19) United States
(12) Patent Application Publication
(10) Pub. No.: US 2017/0153852 A1
(43) Pub. Date: Jun. 1, 2017

(54) MULTI-PORT MEMORY CONTROLLER CAPABLE OF SERVING MULTIPLE ACCESS REQUESTS BY ACCESSING DIFFERENT MEMORY BANKS OF MULTI-BANK PACKET BUFFER AND ASSOCIATED PACKET STORAGE DESIGN

(71) Applicant: MEDIATEK INC., Hsin-Chu (TW)

(72) Inventors: Chang-Po Ma, Hsinchu City (TW); Veng-Chong Lau, New Taipei City (TW); Ting-Chun Chang, Taipei City (TW); Yao-Chun Fang, Tainan City (TW); Pi-Hai Liu, Hsinchu County (TW); Li-Lien Lin, Hsinchu City (TW)

(21) Appl. No.: 15/331,912

(22) Filed: Oct. 23, 2016

Related U.S. Application Data
(60) Provisional application No. 62/260,651, filed on Nov. 30, 2015.

(51) Int. Cl. G06F 3/06

(52) U.S. Cl. CPC G06F 3/0659; G06F 3/0604; G06F 3/0656; G06F 3/064; G06F 3/0631; G06F 3/0679

(57) ABSTRACT

A packet buffer stores packet data of packets received by a master device. The packet buffer includes a non-guaranteed buffer, a guaranteed buffer, and a reserved buffer. The non-guaranteed buffer is visible to the master device, and is not guaranteed to provide one free cell space for one cell in a first-type packet before the non-guaranteed buffer is full. The guaranteed buffer is visible to the master device, and is guaranteed to provide one free cell space for one cell in a second-type packet before the guaranteed buffer is full. The reserved buffer is invisible to the master device, and is arranged to provide headroom for the guaranteed buffer.

### CROSS REFERENCE TO RELATED APPLICATIONS

This application claims the benefit of U.S. provisional application No. 62/260,651, filed on Nov. 30, 2015 and incorporated herein by reference.

### BACKGROUND

The disclosed embodiments of the present invention relate to accessing (reading/writing) packets in a packet buffer, and more particularly, to a multi-port memory controller capable of serving multiple access requests by accessing different memory banks of a multi-bank packet buffer and associated packet storage design.

A network switch is a computer networking device that links different electronic devices. For example, the network switch receives an incoming packet generated from a source electronic device connected to it, and transmits an outgoing packet derived from the received packet to one or more destination electronic devices for which the received packet is meant to be received. In general, the network switch has a packet buffer for buffering packet data of packets received from ingress ports, and forwards the packets stored in the packet buffer through egress ports.

To enhance the storage efficiency of the packet buffer, a packet maybe split into multiple cells, and each cell of the packet is stored into a free cell space found in the packet buffer. To manage packet data stored in the packet buffer, a linked list may be created to link packet cells stored in the packet buffer. For example, one node of the linked list may be associated with a location of a current packet cell and may further indicate a location of a next packet cell. With regard to a high-speed network switch, the transmission clock frequency and/or the data width per transmission clock cycle may be increased. Hence, there is a challenge for the packet buffer design and associated linked list design that are capable of satisfying the high throughput requirement of the high-speed network switch.

### SUMMARY

In accordance with exemplary embodiments of the present invention, a multi-port memory controller capable of serving multiple access requests by accessing different memory banks of a multi-bank packet buffer and associated packet storage design are proposed.

According to a first aspect of the present invention, an exemplary packet buffer for storing packet data of packets received by a master device is disclosed. The exemplary packet buffer includes a non-guaranteed buffer, a guaranteed buffer, and a reserved buffer. The non-guaranteed buffer is visible to the master device, and is not guaranteed to provide one free cell space for one cell in a first-type packet before the non-guaranteed buffer is full. The guaranteed buffer is visible to the master device, and is guaranteed to provide one free cell space for one cell in a second-type packet before the guaranteed buffer is full. The reserved buffer is invisible to the master device, and is arranged to provide headroom for the guaranteed buffer.

According to a second aspect of the present invention, an exemplary storage system for storing information associated with at least one packet is disclosed. The exemplary storage system includes a packet buffer and a linked list buffer. The packet buffer has a plurality of cell spaces, wherein each packet is split into at least one cell, each cell is stored into one cell space, one cell group is transmitted in one transmission clock cycle, and said one cell group comprises multiple cells belonging to the at least one packet. The linked list buffer is arranged to store a linked list associated with packet data of the at least one packet stored in the packet buffer.

According to a third aspect of the present invention, an exemplary multi-port memory controller is disclosed. The exemplary multi-port memory controller includes a write address generation circuit and a physical to bank mapping circuit. The write address generation circuit is arranged to receive a logical write request of a cell in a packet from a master device and generate at least one write address in response to at least the logical write request. The multi-port memory controller is capable of serving multiple access requests by accessing different memory banks of the multi-bank packet buffer. The write address generation circuit controls selection of the at least one write address according to at least one selection rule. The physical to bank mapping circuit is arranged to map at least one physical write address selected by the write address generation circuit to at least one bank of the multi-bank packet buffer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a network switch according to an embodiment of the present invention.

FIG. 2 is a diagram illustrating a first memory space allocation design of a packet buffer according to an embodiment of the present invention.

FIG. 3 is a diagram illustrating a second memory space allocation design of a packet buffer according to an embodiment of the present invention.

FIG. 4 is a diagram illustrating a first example of a linked list structure for small cells of the same packet according to an embodiment of the present invention.

FIG. 5 is a diagram illustrating a second example of a linked list structure for small cells of the same packet according to an embodiment of the present invention.

FIG. 6 is a diagram illustrating a third example of a linked list structure for small cells of the same packet according to an embodiment of the present invention.

FIG. 7 is a diagram illustrating a fourth example of a linked list structure for small cells of the same packet according to an embodiment of the present invention.

FIG. 8 is a diagram illustrating a first example of a linked list structure for different packets according to an embodiment of the present invention.

FIG. 9 is a diagram illustrating a second example of a linked list structure for different packets according to an embodiment of the present invention.

FIG. 10 is a diagram illustrating a third example of a linked list structure for different packets according to an embodiment of the present invention.

FIG. 11 is a diagram illustrating a fourth example of a linked list structure for different packets according to an embodiment of the present invention.

FIG. 12 is a diagram illustrating an interface between a memory controller and memory banks of a packet buffer according to an embodiment of the present invention.

FIG. 13 is a diagram illustrating a first multi-port memory controller according to an embodiment of the present invention.

FIG. 14 is a diagram illustrating a second multi-port memory controller according to an embodiment of the present invention.

FIG. 15 is a diagram illustrating a third multi-port memory controller according to an embodiment of the present invention.

FIG. 16 is a diagram illustrating a fourth multi-port memory controller according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

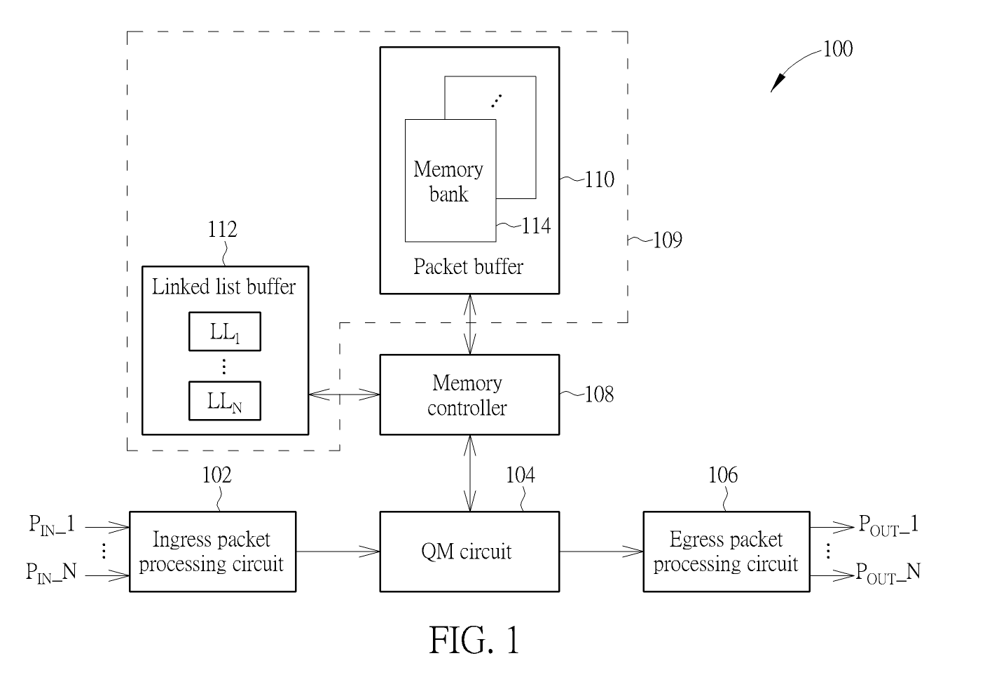

FIG. 1 is a diagram illustrating a network switch according to an embodiment of the present invention. The network switch includes an ingress packet processing circuit 102, a queue manager (QM) circuit 104, an egress packet processing circuit 106, a memory controller (e.g., a multi-port memory controller) 108, and a storage system 109 having a packet buffer 110 and a linked list buffer 112. For example, one or both of the packet buffer 110 and the linked list buffer 112 may be implemented using static random access memories (SRAMs). The ingress packet processing circuit 102 receives ingress packets from a plurality of ingress ports P_{IN}_{_}1-P_{IN}_{_}N, and analyzes each ingress packet to make a forwarding decision. The QM circuit 104 refers to the forwarding decision to store each packet into the packet buffer 110 and enqueue the packet into one output queue associated with one egress port.

Free storage spaces in the packet buffer 110 may be distributed at discontinuous memory locations. Hence, when the network switch 100 receives a packet from an ingress port, the network switch 100 may split the packet into cells and store the cells into discontinuous memory locations of the packet buffer 110. To relax the memory requirement of the output queue, a linked list may be employed to serve as one output queue. Hence, the memory controller 108 manages the linked list buffer 112 in response to packet enqueue commands and packet dequeue commands issued from the QM circuit 104. The linked list buffer 112 is arranged to store a plurality of linked lists LL₁-LL_{N} serving as output queues associated with the egress ports P_{OUT}_{_}1-P_{OUT}_{_}N, respectively.

For example, packets received from the ingress ports P_{IN}_{_}1-P_{IN}_{_}N and judged to be forwarded to the same egress port P_{OUT}_{_}M (1≦M≦N) are enqueued into an output queue implemented by a linked list LL_{M} created and stored in the linked list buffer 112, where the linked list LL_{M} employs a linked list structure to link cells of packets to be forwarded to the same egress port P_{OUT}_{_}M. The QM circuit 104 schedules the output queues, and dequeues at least one packet from a selected output queue. Hence, the QM circuit 104 reads the at least one dequeued packet from the packet buffer 110 and outputs the at least one dequeued packet to the egress packet processing circuit 106, and an associated linked list in the linked list buffer 112 is updated correspondingly. The egress packet processing circuit 106 processes the at least one dequeued packet to generate at least one egress packet, and forwards the at least one egress packet to an egress port associated with the selected output queue. Since a person skilled in the art can readily understand the principle of the ingress packet processing circuit 102 and the egress packet processing circuit 106, further description is omitted here for brevity.

In this embodiment, the network switch 100 is a high-speed network switch. To satisfy the high throughput requirement, the packet buffer 110 may be configured to support a multi-port read/write access. However, using a real large-sized multi-port SRAM to realize the packet buffer 110 with multiple ports results in a high production cost, and needs a long schedule for circuit design and silicon verification. In addition, if the multi-port packet buffer is implemented using multiple memories, there may be dummy bank penalty. The present invention therefore proposes implementing the packet buffer 110 by using one memory (e.g., SRAM) with multiple memory banks and using the memory controller (e.g., multi-port memory controller) 108 for serving multiple access requests (i.e., multiple read/write requests) by accessing different memory banks of the multi-bank packet buffer.

As shown in FIG. 1, the packet buffer 110 is a memory (e.g., SRAM) configured to have multiple memory banks 114, where different memory banks 114 can be accessed independently during the same memory clock cycle. In a case where multiple access requests are directed to different memory banks 114, the packet buffer 110 with multiple memory banks 114 can operate like a multi-port SRAM to serve the multiple access requests at the same time.

However, in another case where at least two of the multiple access requests are directed to a same memory bank 114, bank confliction happens due to the face that one memory bank 114 can only serve one access request at a time. If the packet is a first-type packet (e.g., a lossy packet) and bank confliction occurs, the first-type packet (or cells of the first-type packet) maybe dropped.

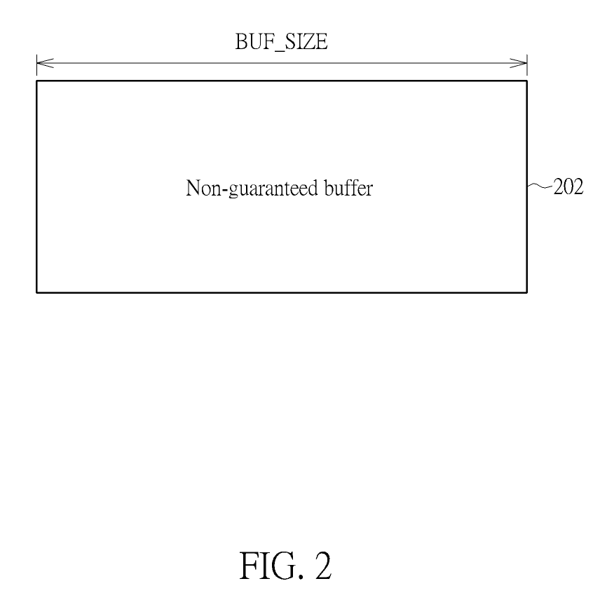

FIG. 2 is a diagram illustrating a first memory space allocation design of a packet buffer according to an embodiment of the present invention. Assuming that the network switch 100 is used to receive and forward first-type packets (e.g., lossy packets) only, the packet buffer 110 can be configured to have a non-guaranteed buffer 202 visible to a master device (e.g., QM circuit 104) that stores the first-type packets into the packet buffer 110. In this case, before the non-guaranteed buffer 202 is full, packet data drop may occur when the free space available in the non-guaranteed buffer 202 is not enough or bank conflict happens. That is, the first-type packet data is allowed to be dropped when write admission of the non-guaranteed buffer 202 is granted but the non-guaranteed buffer 202 is almost full. Since the first-type packet data requested to be stored into the non-guaranteed buffer 202 is not guaranteed (i.e., the first-type packet data can be dropped) before the non-guaranteed buffer 202 is full, no protection mechanism (e.g., “headroom”) is needed in the packet buffer 110 to protect the first-type packet data from being dropped due to bank conflict. As shown in FIG. 2, a buffer size of the non-guaranteed buffer 202 can be substantially equal to a buffer size BUF SIZE of the packet buffer 110. Hence, concerning the packet data buffering, the maximum usage of the packet buffer 110 with the first memory space allocation design is BUF_SIZE.

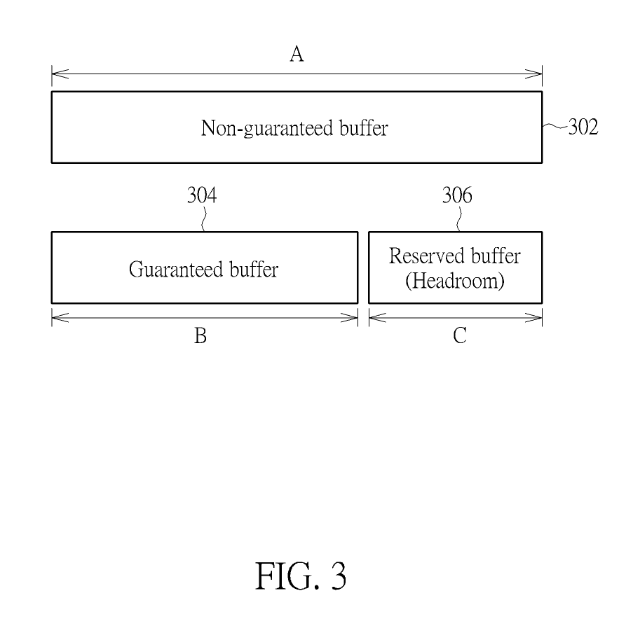

However, if the packet is a second-type packet (e.g., a lossless packet, a control packet, and/or a packet needed to be stored in a reserved area of a guaranteed pool) and bank confliction occurs, the second-type packet (or cells of the second-type packet) cannot be dropped. That is, the second-type packet data is not allowed to be dropped after write admission is granted. Hence, a protection mechanism (e.g., “headroom”) is needed in the packet buffer 110 to protect the second-type packet data from being dropped due to bank conflict. FIG. 3 is a diagram illustrating a second memory space allocation design of a packet buffer according to an embodiment of the present invention. Assuming that the network switch 100 is used to receive and forward first-type packets (e.g., a lossy packet) and second-type packets (e.g., a lossless packet, a control packet, and/or a packet needed to be stored in a reserved area of a guaranteed pool), the packet buffer 110 can be configured to have a non-guaranteed buffer 302, a guaranteed buffer 304, and a reserved buffer 306. The non-guaranteed buffer 302 is visible to a master device (e.g., QM circuit 104) that outputs the received first-type packets to the packet buffer 110. Like the non-guaranteed buffer 202, the non-guaranteed buffer 302 is not guaranteed to provide one free cell space for each cell in a first-type packet before the non-guaranteed buffer 302 is full. For example, when the write admission of the non-guaranteed buffer 302 is granted but the non-guaranteed buffer 302 is almost full, first-type packet data drop may occur if the free space is not enough or bank conflict happens. Since the first-type packet data requested to be stored into the non-guaranteed buffer 302 is not guaranteed (i.e., the first-type packet data can be dropped) before the non-guaranteed buffer 302 is full, no protection mechanism (e.g., “headroom”) is needed to protect the first-type packet data from being dropped due to bank conflict.

The guaranteed buffer 304 is visible to the master device (e.g., QM circuit 104) that outputs the received second-type packets to the packet buffer 110. The guaranteed buffer 304 is guaranteed to provide one free cell space for one cell in a second-type packet before the guaranteed buffer 304 is full. For example, if the write admission of the guaranteed buffer 304 is granted before the guaranteed buffer 304 is full, no second-type packet data drop is allowed. For example, no second-type packet data drop is allowed when bank conflict happens under the condition that the write admission of the guaranteed buffer 304 is granted and the guaranteed buffer 304 is not full. Hence, a protection mechanism (e.g., “headroom”) is needed to protect the second-type packet data from being dropped due to bank conflict. In this embodiment, the reserved buffer 306 is invisible to the master device (e.g., QM circuit 104) that outputs the received second-type packets to the packet buffer 110, and is arranged to provide the needed headroom for the guaranteed buffer 304. For example, the reserved buffer 306 protects the guaranteed buffer 304 by storing one cell in the second-type packet when the cell is to be stored into one memory bank 114 with bank conflict. In other words, one free cell space in another memory bank 114 with no bank conflict is a part of the reserved buffer 306, and can be used to store the cell in the second-type packet to thereby avoid packet data drop.

In one embodiment, a flag recorded in a header of a packet can be checked to classify the packet into the first-type packet or the second-type packet. That is, when a packet has a flag D set by a first value (e.g., D=0), the packet may be classified as the first-type packet to be written into the non-guaranteed buffer 302; and when the packet has the flag D set by a second value (e.g. , D=1), the packet may be classified as the second-type packet to be written into the guaranteed buffer 304. For example, the flag D may be a packet type flag, such as a lossless packet flag (which indicates if the packet is a lossless packet) or a control packet flag (which indicates if the packet is a control packet). For another example, the flag D may be a buffer reservation flag, such as a minimum reserved area flag that indicates if the packet is to be stored into a reserved area of the guaranteed buffer 304. For yet another example, the flag D maybe any packet information flag. The operation of writing a packet into one of the non-guaranteed buffer 302 and the guaranteed buffer 304 may be represented by the following pseudo code.
If flag D=1:
Write a cell of a packet to the guaranteed buffer 304 after write admission of the guaranteed buffer 304 is granted
Else
If a free cell space is got from the non-guaranteed buffer 302, write a cell of a packet to the non-guaranteed buffer 304 after write admission of the non-guaranteed buffer 303 is granted
Else: Drop

As shown in FIG. 3, a buffer size of the non-guaranteed buffer 302 may be set by A, a buffer size of the guaranteed buffer 304 may be set by B, and a buffer size of the reserved buffer 306 may be set by C, where A+B+C=BUF_SIZE. It should be noted that values of A, B and C can be adjusted, depending upon actual design considerations. Since the reserved buffer 306 is used to provide headroom to protect the guaranteed buffer 304 and is invisible to the master device (e.g., QM circuit 104) that uses the packet buffer 110, the maximum usage of the packet buffer 110 with the second memory space allocation design is smaller than the buffer size BUF_SIZE of the packet buffer 110, i.e., A+B<BUF_SIZE.

The throughput of the network switch 100 may depend on the transmission clock frequency and/or the data width per transmission clock cycle. As mentioned above, a packet can be split into multiple cells, and each cell of the packet is stored into a free cell space in the packet buffer 110. If the data width per transmission clock cycle is equal to the packet cell size (i.e., one packet cell is transmitted per transmission clock cycle), the throughput of the network switch 100 may be improved by increasing the packet cell size. However, the actual packet length may vary from 64 bytes to one maximum transmission unit (MTU) such as 9K bytes. Each cell space allocated in the packet buffer is used to buffer one packet cell with the packet cell size. If the packet cell size is set by a large value, the packet buffer may have lower packet data storing efficiency for short packets. For example, if the packet is a 64-byte packet and the packet cell size is much larger than 64 bytes, only one cell space is used to store the packet, and a large portion of the cell space with the packet stored therein is empty. With regard to transmission of short packets, the transmission efficiency of the network switch 100 may be degraded due to a large packet cell size used. The present invention further proposes splitting a packet into smaller cells and transmitting multiple small cells in one transmission clock cycle.

For example, one large cell (logical cell) may be further split into small cells (physical cells) that may be stored in discontinuous cell spaces in the packet buffer 110. In the following, the terms “large cell” and “logical cell” may be interchangeable, and the terms “small cell” and “physical cell” may be interchangeable. With regard to a long packet, multiple small cells may be stored into free small-sized cell spaces allocated in the packet buffer. With regard to a short packet, only one small cell may be stored into one free small-sized cell space allocated in the packet buffer. To put it simply, using a smaller packet cell size can improve the packet data storing efficiency as well as the transmission efficiency.

As mentioned above, a linked list is employed to serve as one output queue, and the memory controller 108 manages the linked list buffer 112 in response to packet enqueue commands and packet dequeue commands issued from the QM circuit 104. Specifically, when receiving a packet enqueue command issued from the QM circuit 104, the memory controller 108 enqueues a packet into one of the output queues (which are implemented using linked lists LL₁-LL_{N}). In other words, a linked list associated with the enqueued packet is updated in the linked list buffer 112. Since the packet is split into small cells and the small cells may be stored into discontinuous free cell spaces found in the packet buffer 110, the present invention further proposes a linked list structure for small cells of the same packet.

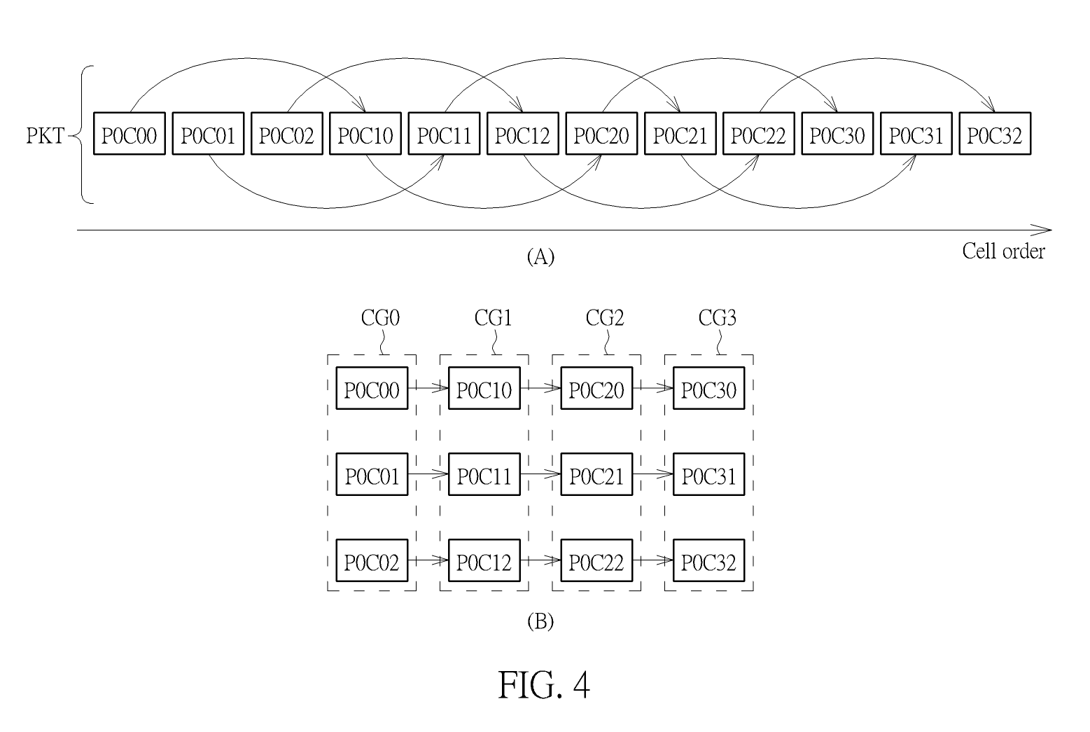

FIG. 4 is a diagram illustrating a first example of a linked list structure for small cells of the same packet according to an embodiment of the present invention. Each packet may be split into at least one small cell, depending upon a packet length of the packet. For example, a short packet may be split into only one small cell, and a long packet may be split into multiple small cells. For clarity and simplicity, a single packet PKT in this example is split into a plurality of successive small cells P0C00, P0001, P0C02, P0C10, P0C11, P0C12, P0C20, P0C21, P0C22, P0C30, P0C31, P0C32, as illustrated in sub-diagram (A) of FIG. 4. In addition, as illustrated in sub-diagram (B) of FIG. 4, the small cells P0C00, P0C01, P0C02 form one logical cell and are included in one cell group CG0 that is transmitted in one transmission clock cycle, the small cells P0C10, P0C11, P0C12 form one logical cell and are included in one cell group CG1 that is transmitted in one transmission clock cycle, the small cells P0C20, P0C21, P0C22 form one logical cell and are included in one cell group CG2 that is transmitted in one transmission clock cycle, and the small cells P0C30, P0C31, P0C32 form one logical cell and are included in one cell group CG3 that is transmitted in one transmission clock cycle. In this embodiment, the number of small cells transmitted by one cell group is 3. If the number of small cells (physical cells) in one packet is an integer multiple of 3, each large cell (logical cell) has 3 small cells forming one cell group transmitted in one transmission clock cycle. If the number of small cells (physical cells) in one packet is not an integer multiple of 3, the last large cell (logical cell) has 1 or 2 small cells. In an embodiment, a cell group transmitted in one transmission clock cycle may include small cell(s) of the last large cell (logical cell) of the packet and small cell(s) of another packet. However, this is for illustrative purposes only, and is not meant to be a limitation of the present invention.

As shown in FIG. 4, a linked list associated with the packet PKT records that the small cell P0C00 of the cell group CG0 is linked to the small cell P0C10 of the cell group CG1, the small cell P0C10 of the cell group CG1 is linked to the small cell P0C20 of the cell group CG2, the small cell P0C20 of the cell group CG2 is linked to the small cell P0C30 of the cell group CG3, the small cell P0C01 of the cell group CG0 is linked to the small cell P0C11 of the cell group CG1, the small cell P0C11 of the cell group CG1 is linked to the small cell P0C21 of the cell group CG2, the small cell P0C21 of the cell group CG2 is linked to the small cell P0C31 of the cell group CG3, the small cell P0C02 of the cell group CG0 is linked to the small cell P0C12 of the cell group CG1, the small cell P0C12 of the cell group CG1 is linked to the small cell P0C22 of the cell group CG2, and the small cell P0C22 of the cell group CG2 is linked to the small cell P0C33 of the cell group CG32. In this example, two small cells (e.g., P0C00 and P0C10) that are not successive cells in the packet PKT and belong to different cell groups (e.g., different logical cells) are linked by the linked list.

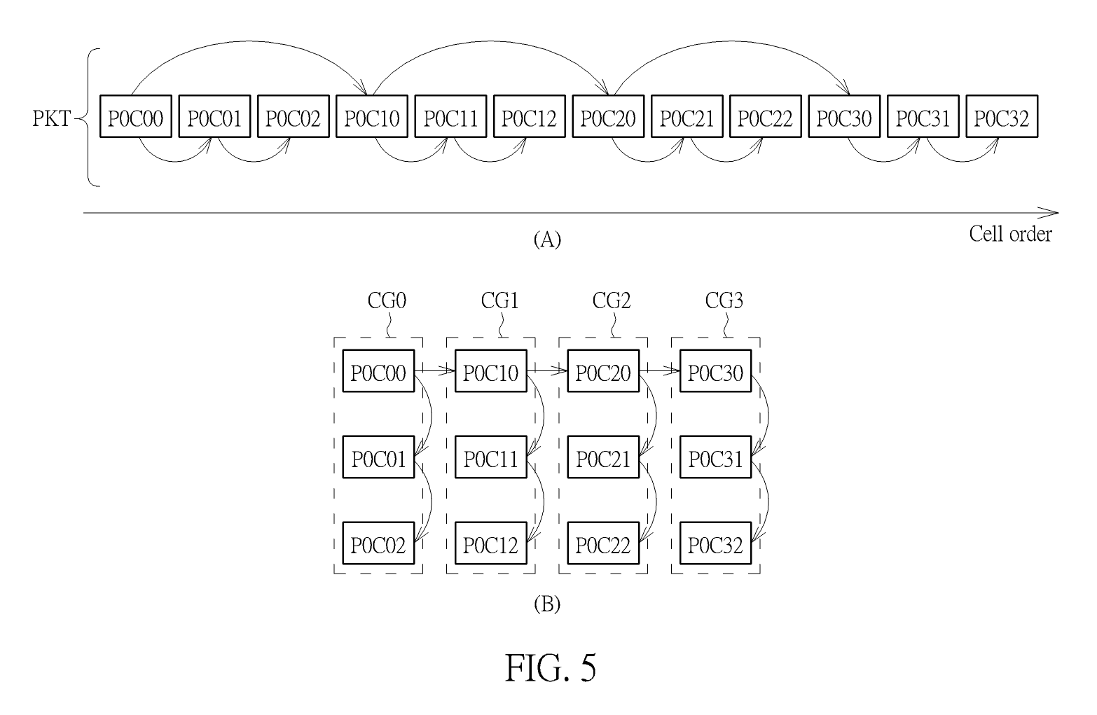

FIG. 5 is a diagram illustrating a second example of a linked list structure for small cells of the same packet according to an embodiment of the present invention. Alternatively, for the same packet PKT shown in FIG. 4, a different linked list structure shown in FIG. 5 may be employed. As shown in sub-diagrams (A) and (B) of FIG. 5, a linked list associated with the packet PKT records that the small cell P0C00 of the cell group CG0 is linked to the small cell P0C10 of the cell group CG1 and the small cell P0C01 of the cell group CG0, the small cell P0C10 of the cell group CG1 is linked to the small cell P0C20 of the cell group CG2 and the small cell P0C11 of the cell group CG1, the small cell P0C20 of the cell group CG2 is linked to the small cell P0C30 of the cell group CG3 and the small cell P0C21 of the cell group CG2, the small cell P0C30 of the cell group CG3 is linked to the small cell P0C31 of the cell group CG3, the small cell P0C01 of the cell group CG0 is linked to the small cell P0C02 of the cell group CG0, the small cell P0C11 of the cell group CG1 is linked to the small cell P0C12 of the cell group CG1, the small cell P0C21 of the cell group CG2 is linked to the small cell P0C22 of the cell group CG2, and the small cell P0C31 of the cell group CG3 is linked to the small cell P0C32 of the cell group CG3. In this example, two small cells (e.g., P0C00 and P0C10) that are not successive cells in the packet PKT and belong to different cell groups (e.g., different logical cells) are linked by the linked list, and one small cell (e.g., P0C00) is linked to multiple small cells (e.g., P0C01 and P0C10) in the same packet PKT.

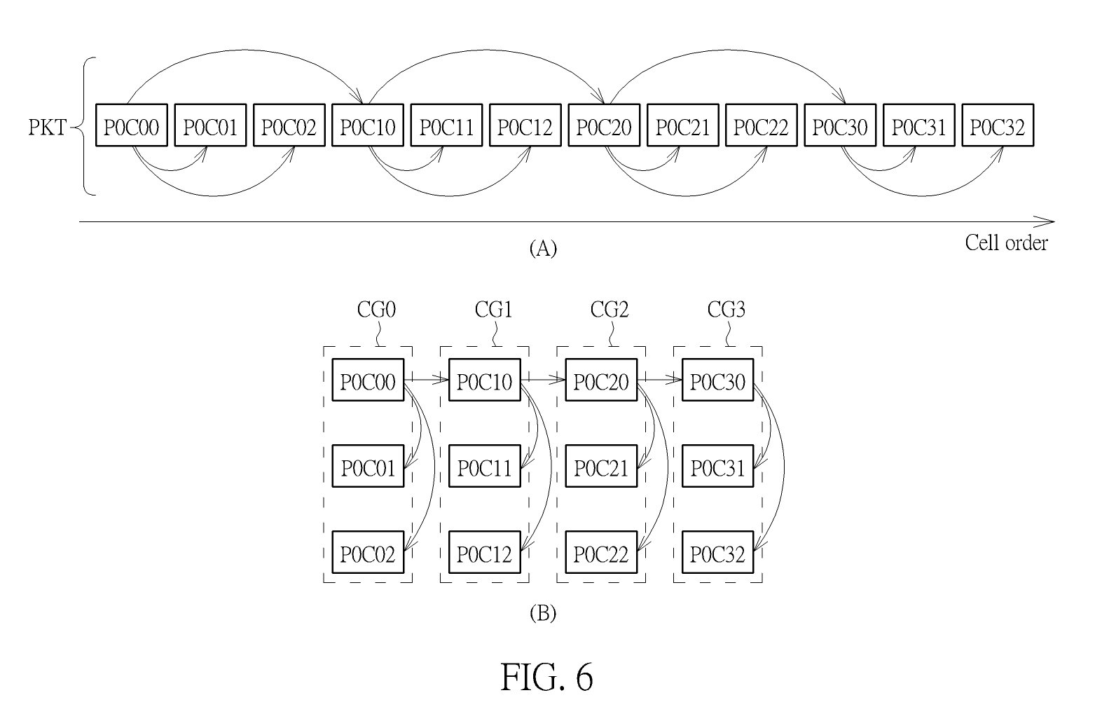

FIG. 6 is a diagram illustrating a third example of a linked list structure for small cells of the same packet according to an embodiment of the present invention. Alternatively, for the same packet PKT shown in FIG. 4, a different linked list structure shown in FIG. 6 may be employed. As shown in sub-diagrams (A) and (B) of FIG. 6, a linked list associated with the packet PKT records that the small cell P0C00 of the cell group CG0 is linked to the small cell P0C10 of the cell group CG1 and the small cells P0C01, P0C02 of the cell group CG0, the small cell P0C10 of the cell group CG1 is linked to the small cell P0C20 of the cell group CG2 and the small cells P0C11, P0C12 of the cell group CG1, the small cell P0C20 of the cell group CG2 is linked to the small cell P0C30 of the cell group CG3 and the small cells P0C21, P0C22 of the cell group CG2, and the small cell P0C30 of the cell group CG3 is linked to the small cells P0C31, P0C32 of the cell group CG3. In this example, two small cells (e.g., P0C00 and P0C10) that are not successive cells in the packet PKT and belong to different cell groups (e.g., different logical cells) are linked by the linked list, two small cells (e.g., P0C00 and P0C02) that are not successive cells in the packet PKT and belong to the same cell group (e.g., the same logical cell) are linked by the linked list, and one small cell (e.g., P0C00) is linked to multiple small cells (e.g., P0C01, P0C02 and P0C10) in the same packet PKT.

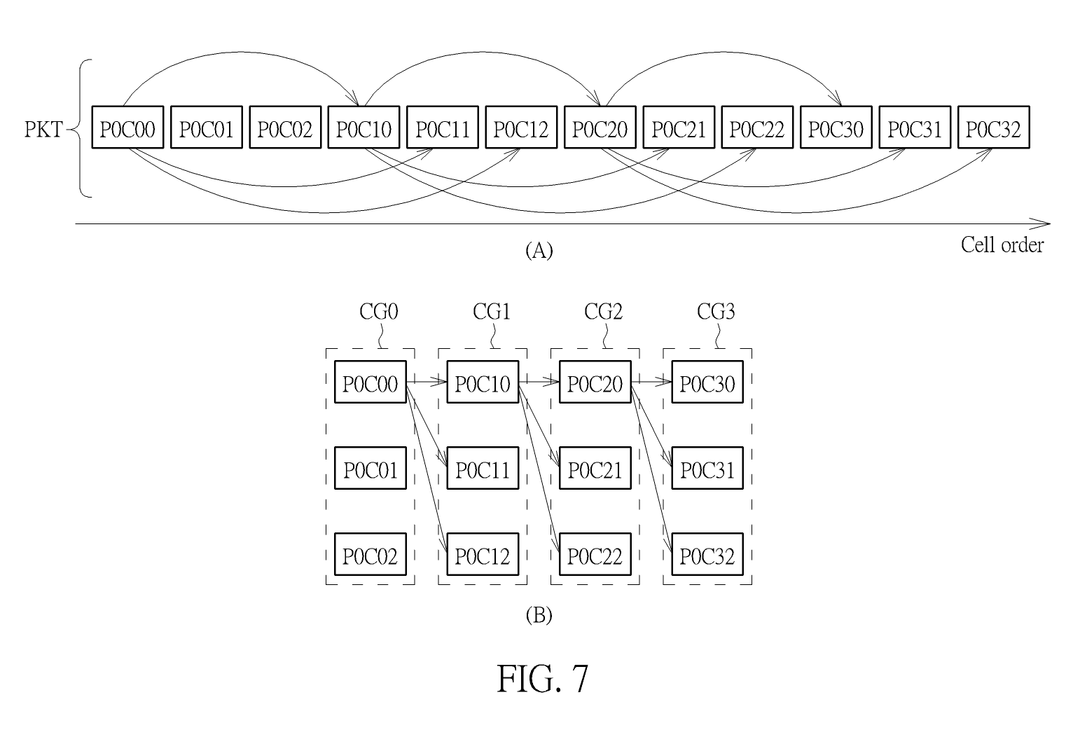

FIG. 7 is a diagram illustrating a fourth example of a linked list structure for small cells of the same packet according to an embodiment of the present invention. Alternatively, for the same packet PKT shown in FIG. 4, a different linked list structure shown in FIG. 7 may be employed. As shown in sub-diagrams (A) and (B) of FIG. 7, a linked list associated with the packet PKT records that the small cell P0C00 of the cell group CG0 is linked to the small cells P0C10, P0C11, P0C12 of the cell group CG1, the small cell P0C10 of the cell group CG1 is linked to the small cells P0C20, P0C21, P0C22 of the cell group CG2, and the small cell P0C20 of the cell group CG2 is linked to the small cells P0C30, P0C31, P0C32 of the cell group CG3. It should be noted that the linked list associated with the packet PKT has no information about the small cells P0C01 and P0C02 of the cell group CG0. In this example, the small cells P0C01 and P0C02 of the cell group CG0 may be stored in pre-defined addresses of the packet buffer 110. In this example, two small cells (e.g., P0C00 and P0C10; or P0C00 and P0C11; or P0C00 and P0C12) that are not successive cells in the packet PKT and belong to different cell groups (e.g., different logical cells) are linked by the linked list, and one small cell (e.g. , P0C00) is linked to multiple small cells (e.g., P0C10, P0C11 and P0C12) in the same packet PKT.

A packet can be split into cells and then stored into the packet buffer 110. However, the master devices (e.g., QM circuit 104) outside the memory controller 108 may not need to use so many cells. For example, the QM circuit 104 may only need to manage enqueue and dequeue of packets by using first cell address of each packet, packet identification (ID) of each packet, etc., and may not need to know how the packet cells are exactly linked. In this way, the production cost and design complexity of the QM circuit 104 can be reduced. Therefore, the present invention further proposes a linked list structure for different packets each being split into small cells.

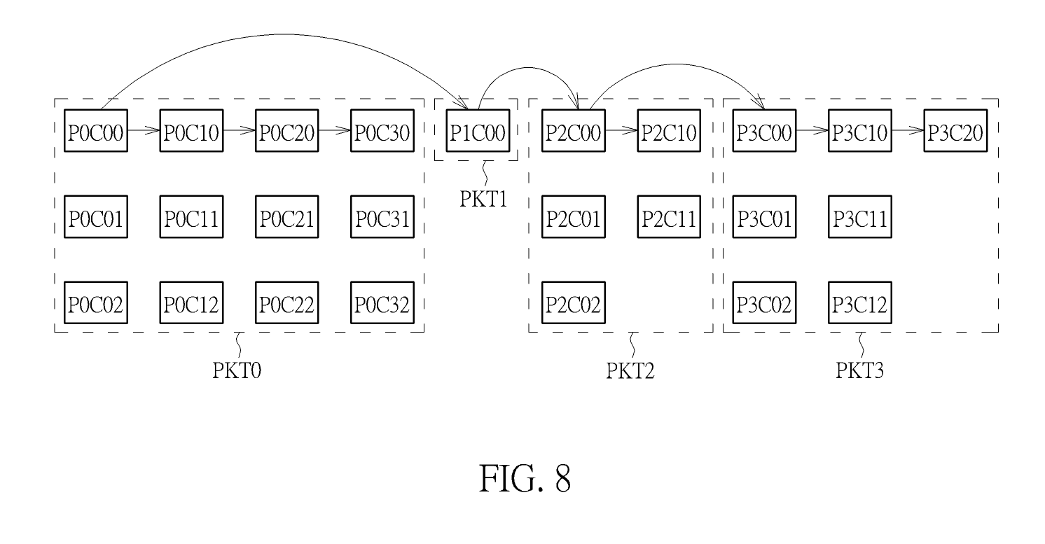

FIG. 8 is a diagram illustrating a first example of a linked list structure for different packets according to an embodiment of the present invention. Each packet may be split into at least one small cell, depending upon a packet length of the packet. For example, a short packet may be split into only one small cell, and a long packet may be split into multiple small cells. In this example, each small cell is denoted by “PxCyz”, where x is a packet index, y is a logical cell index, z is a physical cell index. For example, the first packet PKT0 in FIG. 8 is split into successive small cells P0C00-P0C02, P0C10-P0C12, P0C20-P0C22 and P0C30-P0C32, where small cells P0C00-P0C02 form a first logical cell of the first packet PKT0, small cells P0C10-P0C12 form a second logical cell of the first packet PKT0, small cells P0C20-P0C22 form a third logical cell of the first packet PKT0, and small cells P0C30-P0C32 form a fourth logical cell of the first packet PKT0; the second packet PKT1 is split into one small cell P1C00, where the small cell P1C00 form a single logical cell of the second packet PKT1; the third packet PKT2 is split into small cells P2C00-P2CO2 and P2C10-P2C11, wherein small cells P2C00-P2C02 form a first logical cell of the third packet PKT2, and small cells P2C10-P2C11 form a second logical cell of the third packet PKT2; and the fourth packet PKT3 is split into small cells P3C00-P3C02, P3C10-P3C12 and P3C20, wherein small cells P3C00-P3C02 form a first logical cell of the fourth packet PKT3, small cells P3C10-P3C12 form a second logical cell of the fourth packet PKT3, and the small cell P3C20 form a third logical cell of the fourth packet PKT3. Small cells of the packets PKT0-PKT3 are stored in cell spaces of the packet buffer 110. In this embodiment, one cell group composed of three small cells may be transmitted in one transmission clock cycle. Hence, small cells of the packets PKT0-PKT3 to be forwarded to the same egress port may be read from the packet buffer 110 according to the associated linked list and then arranged in cell groups for transmission.

In this embodiment, the packet identification (ID) of the first packet PKT0 is set by the physical cell address of the small cell P0C00 stored in the packet buffer 110, the packet ID of the second packet PKT1 is set by the physical cell address of the small cell P1C00 stored in the packet buffer 110; the packet ID of the third packet PKT2 is set by the physical cell address of the small cell P2C00 stored in the packet buffer 110, and the packet ID of the fourth packet PKT3 is set by the physical cell address of the small cell P3C00 stored in the packet buffer 110. A linked list associated with the packets PKT0-PKT3 records that the packet ID of the first packet PKT0 is linked to the packet ID of the second packet PKT1, the packet ID of the second packet PKT1 is linked to the packet ID of the third packet PKT2, and the packet ID of the third packet PKT2 is linked to the packet ID of the fourth packet PKT3.

Concerning the first packet PKT0, the linked list also records that the physical cell address of the small cell P0C00 (which belongs to the first logical cell) is linked to the physical cell address of the small cell P0C10 (which belongs to the second logical cell), the physical cell address of the small cell P0C10 (which belongs to the second logical cell) is linked to the physical cell address of the small cell P0C20 (which belongs to the third logical cell), and the physical cell address of the small cell P0C20 (which belongs to the third logical cell) is linked to the physical cell address of the small cell P0C30 (which belongs to the fourth logical cell).

Concerning the third packet PKT2, the linked list also records that the physical cell address of the small cell P2C00 (which belongs to the first logical cell) is linked to the physical cell address of the small cell P2C10 (which belongs to the second logical cell). Concerning the fourth packet PKT3, the linked list also records that the physical cell address of the small cell P3C00 (which belongs to the first logical cell) is linked to the physical cell address of the small cell P3C10 (which belongs to the second logical cell), and the physical cell address of the small cell P3C10 (which belongs to the second logical cell) is linked to the physical cell address of the small cell P3C20 (which belongs to the third logical cell).

For example, when a packet dequeue operation is performed, the master device (e.g., QM circuit 104) may output a packet ID of the first packet PKT0 to be dequeued to the memory controller 108. The memory controller 108 refers to the packet ID of the first packet PKT0 to find a starting linked list node stored at a physical cell address in the linked list buffer 112, where the physical address of the linked list node stored in the linked list buffer 112 may be identical to the physical cell address of the small cell P0C00 stored in the packet buffer. Further, based on a linked list structure of small cells of the same first packet PKT0, the memory controller 108 can read packet data of the dequeued first packet PKT0 from the packet buffer 110. Next, the memory controller 108 refers to a link information stored in the linked list node to find a next linked list node at a physical cell address in the linked list buffer 112, where the next linked list node is associated with the next packet PKT1, and the physical address of the next linked list node stored in the linked list buffer 112 may be identical to the physical cell address of the small cell P1C00 stored in the packet buffer 110. Similarly, based on a linked list structure of the small cell of the same second packet PKT1, the memory controller 108 can read packet data of the dequeued second packet PKT1 from the packet buffer 110. To put it simply, packets PKT0-PKT3 can be successively dequeued and output to an egress port by traversing through the linked list shown in FIG. 8.

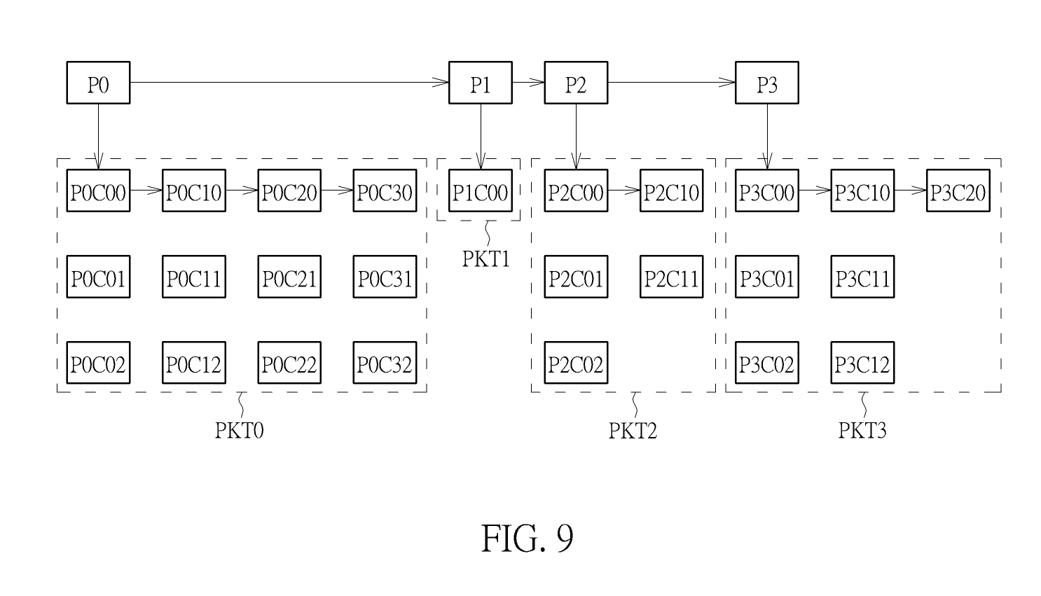

FIG. 9 is a diagram illustrating a second example of a linked list structure for different packets according to an embodiment of the present invention. Alternatively, for the same packets PKT0-PKT3 shown in FIG. 8, a different linked list may be employed. In this embodiment, the packet identification (ID) of the first packet PKT0 is set by a logical cell address P0, the packet ID of the second packet PKT1 is set by a logical cell address P1, the packet ID of the third packet PKT2 is set by a logical cell address P2, and the packet ID of the fourth packet PKT3 is set by a logical cell address P3. A linked list associated with the packets PKT0-PKT3 records that the packet ID of the first packet PKT0 is linked to the packet ID of the second packet PKT1, the packet ID of the second packet PKT1 is linked to the packet ID of the third packet PKT2, and the packet ID of the third packet PKT2 is linked to the packet ID of the fourth packet PKT3. In addition, the linked list associated with the packets PKT0-PKT3 also records that the logical cell address P0 is mapped to the physical cell address of the small cell P0C00 stored in the packet buffer 110, the logical cell address P1 is mapped to the physical cell address of the small cell P1C00 stored in the packet buffer 110, the logical cell address P2 is mapped to the physical cell address of the small cell P2C00 stored in the packet buffer 110, and the logical cell address P3 is mapped to the physical cell address of the small cell P3C00 stored in the packet buffer 110.

Concerning the first packet PKT0, the linked list also records that the physical cell address of the small cell P0C00 (which belongs to the first logical cell) is linked to the physical cell address of the small cell P0C10 (which belongs to the second logical cell), the physical cell address of the small cell P0C10 (which belongs to the second logical cell) is linked to the physical cell address of the small cell P0C20 (which belongs to the third logical cell), and the physical cell address of the small cell P0C20 (which belongs to the third logical cell) is linked to the physical cell address of the small cell P0C30 (which belongs to the fourth logical cell). Concerning the third packet PKT2, the linked list also records that the physical cell address of the small cell P2C00 (which belongs to the first logical cell) is linked to the physical cell address of the small cell P2C10 (which belongs to the second logical cell). Concerning the fourth packet PKT3, the linked list also records that the physical cell address of the small cell P3C00 (which belongs to the first logical cell) is linked to the physical cell address of the small cell P3C10 (which belongs to the second logical cell), and the physical cell address of the small cell P3C10 (which belongs to the second logical cell) is linked to the physical cell address of the small cell P3C20 (which belongs to the third logical cell).

For example, when a packet dequeue operation is performed, the master device (e.g., QM circuit 104) may output a packet ID of the first packet PKT0 to the memory controller 108. The memory controller 108 refers to the packet ID of the first packet PKT0 to find a starting linked list node stored at a physical cell address in the linked list buffer 112, where the physical address of the linked list node is identical to the logical cell address as indicated by the packet ID of the first packet PKT0. The memory controller 108 may refer to the mapping information in the linked list node to determine the physical cell address of the small cell P0C00 stored in the packet buffer. Further, based on a linked list structure of small cells of the same first packet PKT0, the memory controller 108 can read packet data of the dequeued first packet PKT0 from the packet buffer 110. Next, the memory controller 108 refers to a link information stored in the linked list node to find a next linked list node at a physical cell address in the linked list buffer 112, where the next linked list node is associated with the next packet PKT1, and the physical address of the next linked list node is identical to the logical cell address set to the packet ID of the second packet PKT1. Similarly, the memory controller 108 may refer to the mapping information in the next linked list node to determine the physical cell address of the small cell P1C00 stored in the packet buffer 100. Further, based on a linked list structure of the small cell of the same second packet PKT1, the memory controller 108 can read packet data of the dequeued second packet PKT1 from the packet buffer 110. To put it simply, packets PKT0-PKT3 can be successively dequeued and output to an egress port by traversing through the linked list shown in FIG. 9.

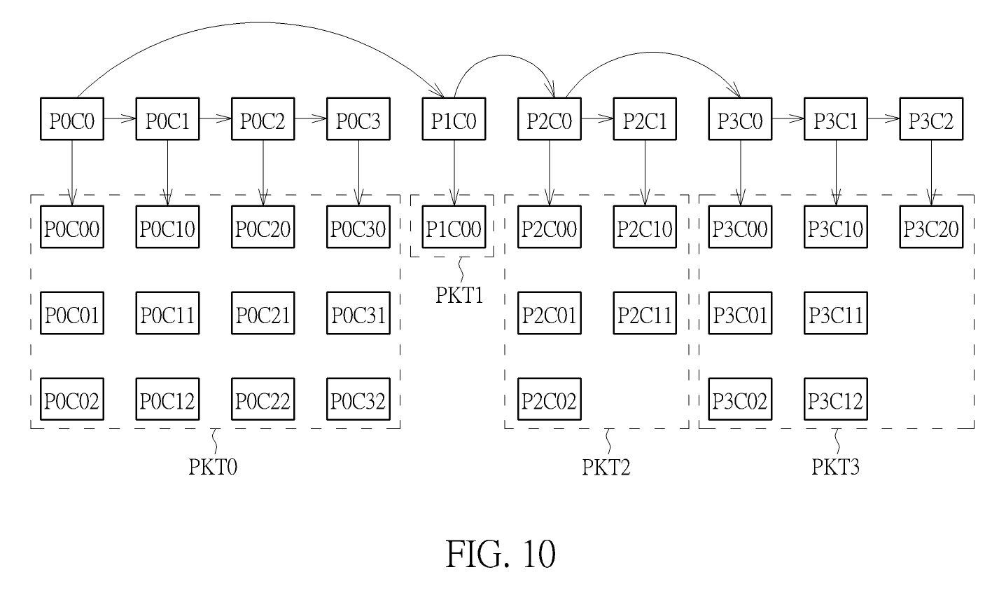

FIG. 10 is a diagram illustrating a third example of a linked list structure for different packets according to an embodiment of the present invention. Alternatively, for the same packets PKT0-PKT3 shown in FIG. 8, a different linked list may be employed. In this embodiment, the packet identification (ID) of the first packet PKT0 is set by a logical cell address P0CO, the packet ID of the second packet PKT1 is set by a logical cell address P1C0, the packet ID of the third packet PKT2 is set by a logical cell address P2C0, and the packet ID of the fourth packet PKT3 is set by a logical cell address P3C0. A linked list associated with the packets PKT0-PKT3 records that the packet ID of the first packet PKT0 is linked to the packet ID of the second packet PKT1, the packet ID of the second packet PKT1 is linked to the packet ID of the third packet PKT2, and the packet ID of the third packet PKT2 is linked to the packet ID of the fourth packet PKT3. Concerning the first packet PKT0, the linked list also records that the logical cell address P0C0 of the first logical cell is linked to the logical cell address P0C1 of the second logical cell, the logical cell address P0C1 of the second logical cell is linked to the logical cell address P0C2 of the third logical cell, and the logical cell address P0C2 of the third logical cell is linked to the logical cell address P0C3 of the fourth logical cell. Concerning the third packet PKT2, the linked list also records that the logical cell address P2C0 of the first logical cell is linked to the logical cell address P2C1 of the second logical cell. Concerning the fourth packet PKT3, the linked list also records that the logical cell address P3C0 of the first logical cell is linked to the logical cell address P3C1 of the second logical cell, and the logical cell address P3C1 of the second logical cell is linked to the logical cell address P3C2 of the third logical cell.

In this embodiment, the linked list associated with the packets PKT0-PKT3 further records that the logical cell address P0CO is mapped to physical cell addresses of all small cells P0C00-P0C02 that belong to the same logical cell and are stored in the packet buffer 110, the logical cell address P0C1 is mapped to physical cell addresses of all small cells P0C10-P0C12 that belong to the same logical cell and are stored in the packet buffer 110, the logical cell address P0C2 is mapped to physical cell addresses of all small cells P0C20-P0C22 that belong to the same logical cell and are stored in the packet buffer 110, the logical cell address P0C3 is mapped to physical cell addresses of all small cells P0C30-P0C32 that belong to the same logical cell and are stored in the packet buffer 110, the logical cell address P1C0 is mapped to the physical cell address of the small cell P1C00 that belongs to one logical cell and is stored in the packet buffer 110, the logical cell address P2C0 is mapped to physical cell addresses of all small cells P2C00-P2C02 that belong to the same logical cell and are stored in the packet buffer 110, the logical cell address P2C1 is mapped to physical cell addresses of all small cells P2C10-P2C11 that belong to the same logical cell and are stored in the packet buffer 110, the logical cell address P3C0 is mapped to physical cell addresses of all small cells P3C00-P3C02 that belong to the same logical cell and are stored in the packet buffer 110, the logical cell address P3C1 is mapped to physical cell addresses of all small cells P3C10-P3C12 that belong to the same logical cell and are stored in the packet buffer 110, and the logical cell address P3C2 is mapped to the physical cell address of the small cell P3C20 that belongs to one logical cell and is stored in the packet buffer 110.

For example, when a packet dequeue operation is performed, the master device (e.g., QM circuit 104) may output a packet ID of the first packet PKT0 to the memory controller 108. The memory controller 108 refers to the packet ID of the first packet PKT0 to find a starting linked list node stored at a physical cell address in the linked list buffer 112, where the physical address of the linked list node is identical to the logical cell address as indicated by the packet ID of the first packet PKT0. The memory controller 108 may refer to the link information in the linked list node to find a next linked list node at a physical address in the linked list buffer 112, where the next linked list node is associated with the next logical cell P0C1, and the physical address of the next linked list node is identical to the logical cell address P0C1. Similarly, the next linked list nodes associated with the remaining logical cells of the first packet PKT0 can be found. The memory controller 108 may refer to mapping information in the linked list nodes associated with the first packet PKT0 to determine the physical cell addresses of small cells P0C00-P0C02, P0C10-P0C12, P0C20-P0C22, P0C30-P0C32 stored in the packet buffer 110. Next, the memory controller 108 refers to a link information stored in the linked list node found using the logical cell address P0CO to find a next linked list node at a physical cell address in the linked list buffer 112, where the next linked list node is associated with the next packet PKT1, and the physical address of the next linked list node is identical to the logical cell address P1C0 set to the packet ID of the second packet PKT1. Similarly, the memory controller 108 may refer to the mapping information in the next linked list node to determine the physical cell address of the small cell P1C00 stored in the packet buffer 100. To put it simply, packets PKT0-PKT3 can be successively dequeued and output to an egress port by traversing through the linked list shown in FIG. 10.

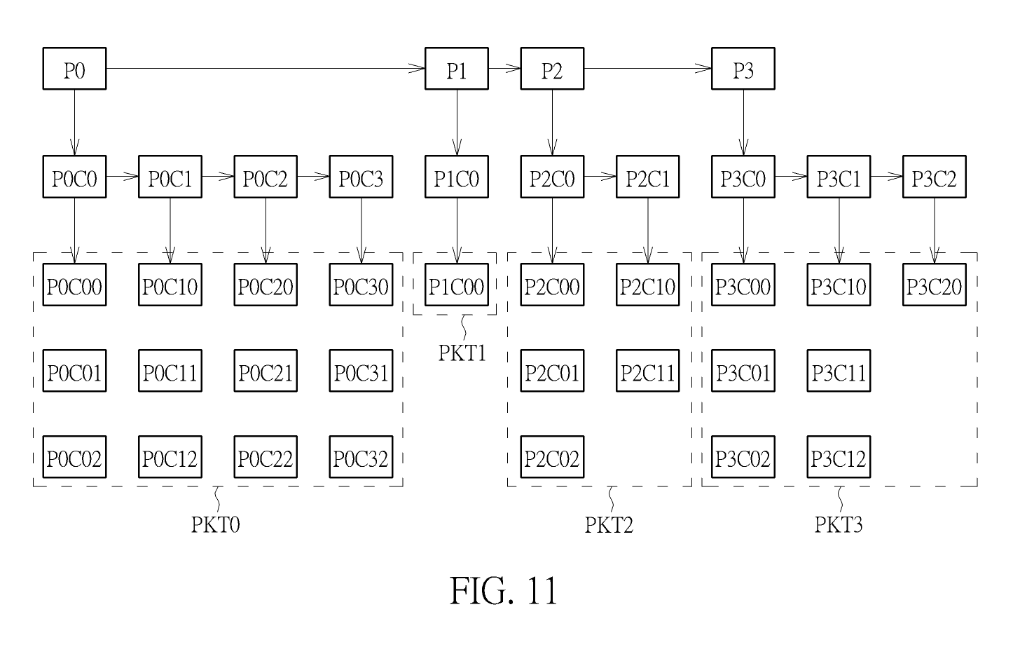

FIG. 11 is a diagram illustrating a fourth example of a linked list structure for different packets according to an embodiment of the present invention. Alternatively, for the same packets PKT0-PKT3 shown in FIG. 8, a different linked list may be employed. In this embodiment, the packet identification (ID) of the first packet PKT0 is set by a logical packet address P0, the packet ID of the second packet PKT1 is set by a logical packet address P1, the packet ID of the third packet PKT2 is set by a logical packet address P2, and the packet ID of the fourth packet PKT3 is set by a logical packet address P3. A linked list associated with the first packet PKT0, the second packet PKT1, the third packet PKT2 and the fourth packet PKT3 records that the packet ID of the first packet PKT0 is linked to the packet ID of the second packet PKT1, the packet ID of the second packet PKT1 is linked to the packet ID of the third packet PKT2, and the packet ID of the third packet PKT2 is linked to the packet ID of the fourth packet PKT3. Concerning the first packet PKT0, the linked list also records that the logical packet address P0 is mapped to the logical cell address P0C0 of the first logical cell, the logical cell address P0C0 is linked to the logical cell address P0C1 of the second logical cell, the logical cell address P0C1 is linked to the logical cell address P0C2 of the third logical cell, and the logical cell address P0C2 is linked to the logical cell address P0C3 of the fourth logical cell. Concerning the third packet PKT2, the linked list also records that the logical packet address P2 is mapped to the logical cell address P2C0 of the first logical cell, and the logical cell address P2C0 is linked to the logical cell address P2C1 of the second logical cell. Concerning the fourth packet PKT3, the linked list also records that the logical packet address P3 is mapped to the logical cell address P3C0 of the first logical cell, the logical cell address P3C0 is linked to the logical cell address P3C1 of the second logical cell, and the logical cell address P3C1 is linked to the logical cell address P3C2 of the third logical cell.

In this embodiment, the linked list associated with the packets PKT0-PKT3 further records that the logical cell address P0C0 is mapped to physical cell addresses of all small cells P0C00-P0C02 that belong to the same logical cell and are stored in the packet buffer 110, the logical cell address P0C1 is mapped to physical cell addresses of all small cells P0C10-P0C12 that belong to the same logical cell and are stored in the packet buffer 110, the logical cell address P0C2 is mapped to physical cell addresses of all small cells P0C20-P0C22 that belong to the same logical cell and are stored in the packet buffer 110, the logical cell address P0C3 is mapped to physical cell addresses of all small cells P0C30-P0C32 that belong to the same logical cell and are stored in the packet buffer 110, the logical cell address P1C0 is mapped to the physical cell address of the small cell P1C00 that belongs to one logical cell and is stored in the packet buffer 110, the logical cell address P2C0 is mapped to physical cell addresses of all small cells P2C00-P2C02 that belong to the same logical cell and are stored in the packet buffer 110, the logical cell address P2C1 is mapped to physical cell addresses of all small cells P2C10-P2C11 that belong to the same logical cell and are stored in the packet buffer 110, the logical cell address P3C0 is mapped to physical cell addresses of all small cells P3C00-P3C02 that belong to the same logical cell and are stored in the packet buffer 110, the logical cell address P3C1 is mapped to physical cell addresses of all small cells P3C10-P3C12 that belong to the same logical cell and are stored in the packet buffer 110, and the logical cell address P3C2 is mapped to the physical cell address of the small cell P3C20 that belongs to one logical cell and is stored in the packet buffer 110.

For example, when a packet dequeue operation is performed, the master device (e.g., QM circuit 104) may output a packet ID of the first packet PKT0 to the memory controller 108. The memory controller 108 refers to the packet ID of the first packet PKT0 to find a starting linked list node stored at a physical address in the linked list buffer 112, where the physical address of the linked list node is identical to the logical packet address as indicated by the packet ID of the first packet PKT0. The memory controller 108 may refer to the mapping information in the linked list node stored at the logical packet address PO to find a next linked list node stored at the logical cell address P0C0. Similarly, the linked list nodes associated with the remaining logical cells of the first packet PKT0 can be found by traversing through the linked list. The memory controller 108 may refer to mapping information in the linked list nodes associated with the first packet PKT0 to determine the physical cell addresses of small cells P0C00-P0C02, P0C10-P0C12, P0C20-P0C22, P0C30-P0C32 stored in the packet buffer 110.

Next, the memory controller 108 refers to a link information stored in the linked list node stored at the logical packet address P0 to find a next linked list node stored at the logical packet address P1, where the next linked list node is associated with the next packet PKT1. Similarly, the memory controller 108 may refer to the mapping information in the linked list node stored at the logical cell address P1 to find the next linked list node stored at the logical packet address P1C0, and refers to the mapping information in the next linked list node stored at the logical cell address P1C0 to determine the physical cell address of the small cell P1C00 stored in the packet buffer 100. To put it simply, packets PKT0-PKT3 can be successively dequeued and output to an egress port by traversing through the linked list shown in FIG. 11.

As shown in FIG. 1, the packet buffer 110 is a multi-bank packet buffer with multiple memory banks 114 that can be accessed independently in the same clock cycle. Hence, in a case where each of the memory banks 114 is a single-channel memory bank (e.g., 1RW memory bank), the packet buffer 110 can operate like a multi-port memory if different memory banks are accessed in the same clock cycle. In another case where each of the memory banks 114 is one a-channel memory bank (e.g., aRW memory bank or bRcW memory bank, where b+c=a), the packet buffer 110 can operate like an m-port memory if different memory banks are accessed in the same clock cycle, where n>1, m>1 and m>n. With a proper selection of memory banks used for serving multiple access requests issued from the master device (e.g., QM circuit 104), the packet buffer 110 can satisfy the high throughput requirement of the high-speed network switch. In this embodiment, the memory controller 108 may be a multi-port memory controller responsible for making a proper memory bank selection, thereby increasing the possibility of serving multiple access requests by using different memory banks of the packet buffer 110. Further details of the proposed memory bank selection design are described as below.

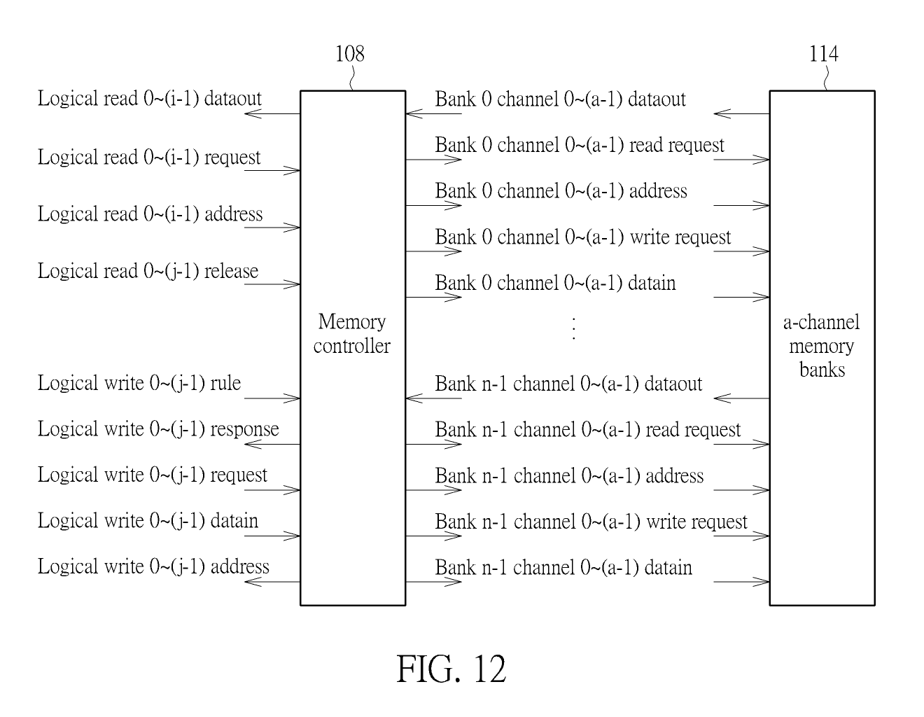

FIG. 12 is a diagram illustrating an interface between the memory controller 108 and the memory banks 114 of the packet buffer 110 according to an embodiment of the present invention. In this embodiment, the memory controller 108 is a multi-port memory controller with i logical read port(s) and j logical write port(s), where i≧1 and j≧1. In addition, the packet buffer 110 is configured to have n memory banks (e.g., bank 0 to bank n−1), and each of the memory banks 114 has a channel(s), where n>1 and a≧1. That is, the packet buffer 110 is a multi-bank packet buffer, and the number of concurrent memory accesses allowed to be performed by each of the memory banks 114 in one clock cycle is equal to a. In a first exemplary design, each of the memory banks 114 may be one aRW memory bank that allows either aR or aW in one clock cycle. Ina second exemplary design, each of the memory banks 114 may be one bRcW memory bank, where b+c=a. In a third exemplary design, the memory banks 114 may include a combination of aRW memory banks and bRcW memory banks.

As shown in FIG. 12, each logical read port of the memory controller 108 can receive a logical read request signal, a logical read address signal and a logical read release signal from a master device (e.g., QM circuit 104) and can transmit a logical read dataout signal to the master device (e.g., QM circuit 104); and each logical write port of the memory controller 108 can receive a logical write rule signal, a logical write request signal and a logical write datain signal from the master device (e.g., QM circuit 104) and can transmit a logical write response signal and a logical write address signal to the master device (e.g., QM circuit 104). When a logical read port receives a logical read request and a logical read address signal issued from the master device (e.g., QM circuit 104), the memory controller 108 refers to the logical read address received by the logical read port to determine a target memory bank that has the requested data, selects one available channel of the target memory bank to serve as a read channel, and generate a read request signal and a read address signal to the target memory bank via the selected read channel. The target memory bank outputs the requested data (i.e., a data out signal) to the memory controller 108 via the selected read channel, and the memory controller 108 generates the logical read dataout signal to the master device (e.g., QM circuit 104) according to the requested data provided by the target memory bank. If the logical read release signal is also issued from the master device (e.g., QM circuit 104) to the logical read port of the memory controller 108, the memory controller 108 will release the memory space occupied by the requested data after the requested data is read from the target memory bank and transmitted to the master device (e.g., QM circuit 104).

To reduce the occurrence probability of bank conflict (i.e., a condition where a memory bank is unable to serve all access requests in one clock cycle due to that the number of access requests for concurrently accessing the same memory bank exceeds the number of channels supported by the memory bank), the write address is not set by the master device (e.g., QM circuit 104), and is controlled/selected by the memory controller 108. When a logical write port receives a logical write request and a logical write datain signal issued from the master device (e.g., QM circuit 104), the memory controller 108 selects a target memory bank from the memory banks, determines a write address for storing the write data into the target memory bank, selects one available channel of the target memory bank to serve as a write channel, generates a write request signal, a write address signal and a write datain signal to the target memory bank via the selected write channel, and outputs the write address signal to inform the master device (e.g., QM circuit 104) of the selected write address. If the logical write rule signal is issued from the master device (e.g., QM circuit 104) and received by the logical write port, the write address selection performed by the memory controller 108 is further constrained by the write rule. If the memory controller 108 judges that bank conflict happens or bank conflict is about to happen, the memory controller 108 generates the logical write response signal to inform the master device (e.g., QM circuit 104). Further details of the memory controller 108 are described as below.

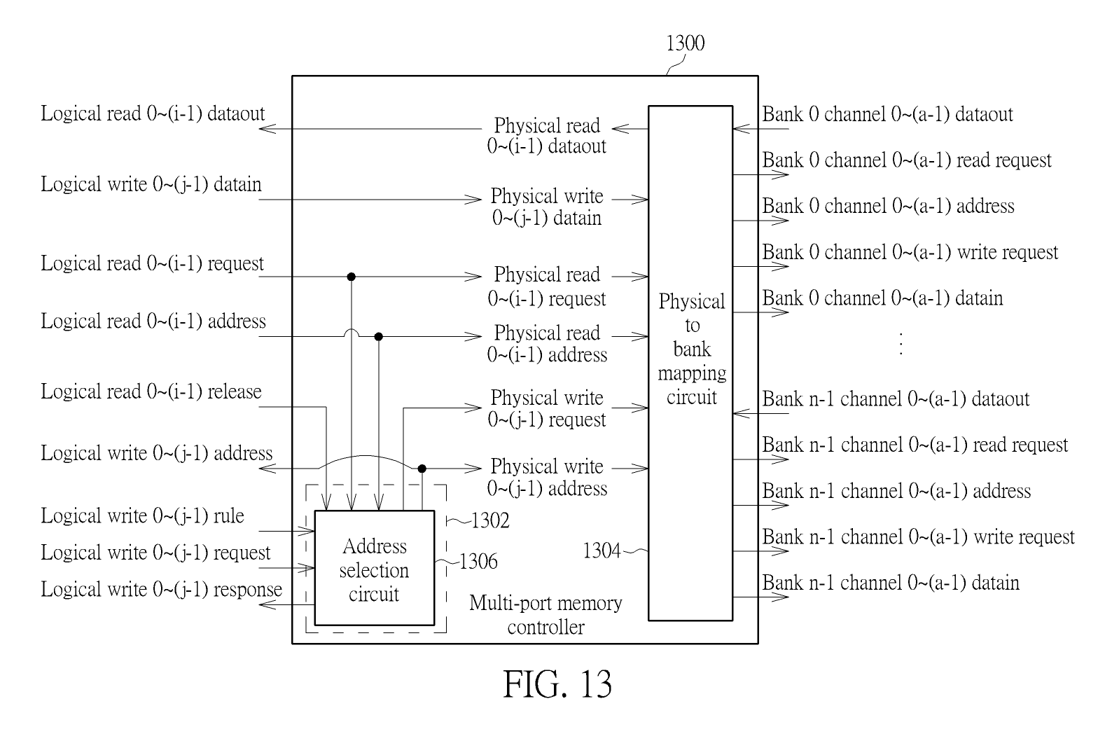

FIG. 13 is a diagram illustrating a first multi-port memory controller according to an embodiment of the present invention. The memory controller 108 may be implemented using the multi-port memory controller 1300 shown in FIG. 13. The multi-port memory controller 1300 includes a write address generation circuit 1302 and a physical to bank mapping circuit 1304. In this embodiment, the write address generation circuit 1302 is implemented using an address selection circuit 1306. In this embodiment, the write address is not allowed to be set by a master device (e.g., QM circuit 104), and is controlled/selected by the multi-port memory controller 1300. After initialization, there is a free physical cell pool (i.e., free cell space pool) available to the address selection circuit 1306, where the free physical cell pool is created by collecting free cell spaces in each of the memory banks 114 of the packet buffer 110. The free cell spaces may be good cell spaces according to a test result showing no SRAM errors. A packet is split into cells, and each cell of the packet is stored into one free cell space of one memory bank 114. In this embodiment, a logical cell address is equal to a physical cell address, such that no mapping between the logical cell address and the physical cell address is required. When retrieving read data from the packet buffer 110, the multi-port memory controller 1300 reads the memory banks 114 according to the logical read requests and associated logical read addresses. When it is the last time to read one requested packet cell, a logical read release signal is received by the multi-port memory controller 1300, and a cell space occupied by the requested packet cell will be released to the free physical cell pool under the control of the address selection circuit 1306.

When storing write data into the packet buffer 110, the address selection circuit 1306 receives a logical write request of a packet from a master device (e.g., QM circuit 104), and generates at least one physical write address for at least one cell (e.g., large cell(s) or small cell(s)) of the packet in response to at least the logical write request, and the physical to bank mapping circuit 1304 maps the at least one physical write address to at least one memory bank 114 of the packet buffer 110. In this embodiment, the address selection circuit 1306 of the write address generation circuit 1302 controls selection of the at least one physical write address according to at least one selection rule. For example, in accordance with the at least one selection rule, cells of the same packet are written into different memory banks per clock cycle, the access of each memory bank does not exceed the maximum throughput of the memory bank (i.e., the number of concurrent memory accesses (read operations and/or write operations) of one memory bank should not be larger than the number of channels supported by the memory bank), free cell spaces are used, good cell spaces that pass the test are used, and/or cell usage balance of memory banks is achieved by bank selection. When the logical write rule is also issued from the master device (e.g., QM circuit 104), the at least one selection rule used by the address selection circuit 1306 includes the received logical write rule for controlling selection of the at least one physical write address.

The logical write rule may select pre-defined cell spaces. For example, in accordance with the logical write rule received by the address selection circuit 1306, cells of the same packet are written into different address locations, a cell with an SOP (start of packet)/EOP (end of packet) flag or an ENQ (enqueue) flag is stored at a corresponding pre-defined address location, a cell with a lossless flag or a lossy flag is stored at a corresponding pre-defined address location, a packet with a particular packet type (e.g., a packet with a guaranteed flag) is forced to be stored into a guaranteed buffer, a packet with another particular packet type (e.g., a packet with a non-guaranteed flag) is forced to be stored into a non-guaranteed buffer, the guaranteed buffer has a minimum guaranteed storage space for each ingress port, the accounting information of cells received from an ingress port and stored in the guaranteed buffer is checked, and/or information related to a packet or a cell is checked.

In addition, the address selection circuit 1306 further generates a logical write response to the master device (e.g., QM circuit 104). For a lossy packet write operation, the logical write response may indicate that the logical write request has been dropped due to bank conflict of the multi-bank packet buffer. For a lossless packet write operation, the logical write response may indicate that bank conflict of the multi-bank packet buffer is about to happen in the multi-bank packet buffer. Hence, when being notified by the logical write response, the master device (e.g., QM circuit 104) may reduce its packet data output throughput to avoid the packet data drop.

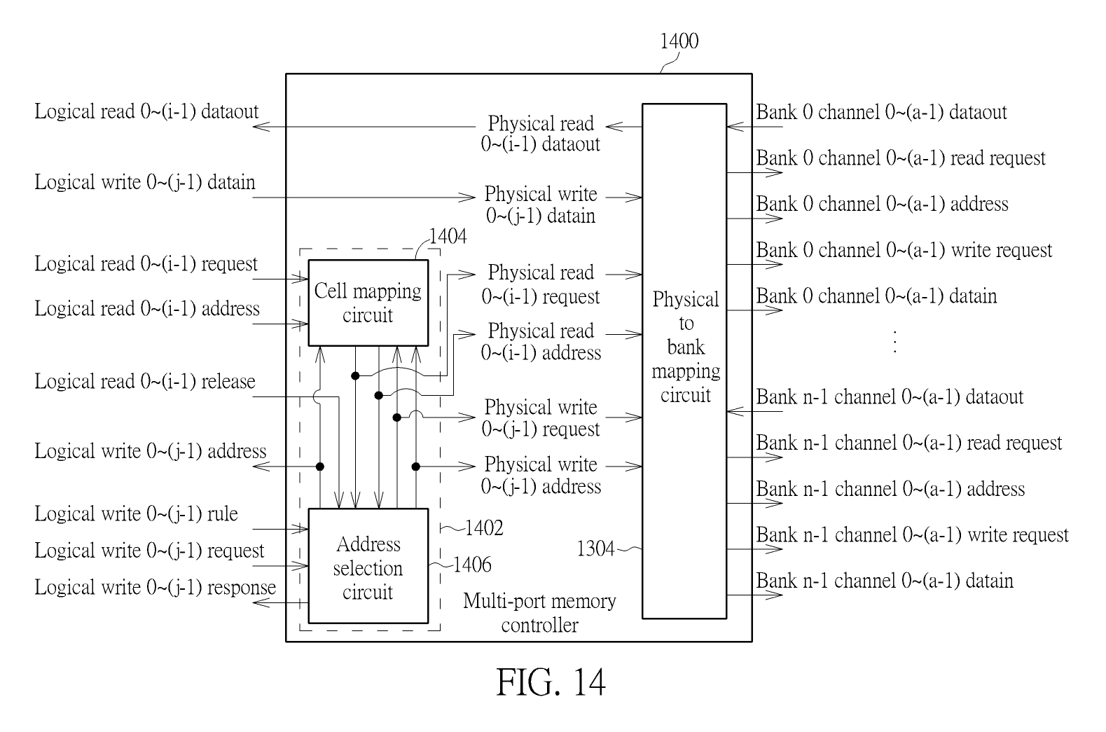

FIG. 14 is a diagram illustrating a second multi-port memory controller according to an embodiment of the present invention. The memory controller 108 maybe implemented using the multi-port memory controller 1400 shown in FIG. 14. In this embodiment, mapping between a logical cell address and a physical cell address is implemented, such that the logical cell address is not necessarily equal to the physical cell address. The major difference between the multi-port memory controllers 1300 and 1400 is that the write address generation circuit 1402 includes a cell mapping circuit 1404 and an address selection circuit 1406, where the address selection circuit 1406 controls physical write address selection and logical write address selection, and the cell mapping circuit 1404 records mapping between physical cell addresses and logical cell addresses.

When storing write data into the packet buffer 110, the address selection circuit 1406 receives a logical write request of a packet from a master device (e.g., QM circuit 104), and generates at least one physical write address and at least one logical write address for at least one cell (e.g., large cell(s) or small cell(s)) of the packet in response to at least the logical write request, and the cell mapping circuit 1404 records the mapping between the at least one logical write address and the at least one physical write address selected by the address selection circuit 1406. Next, the physical to bank mapping circuit 1304 maps the at least one physical write address to at least one memory bank 114 of the packet buffer 110.

The physical write address selection performed by the address selection circuit 1406 is identical to that performed by the aforementioned address selection circuit 1306. In other words, concerning the physical write address selection, the same selection rules employed by the address selection circuit 1306 may also be employed by the address selection circuit 1406. Further description is omitted here for brevity.

With regard to the logical write address selection performed by the address selection circuit 1406, the selection rules are similar to that used for physical write address selection. For example, in addition to a free physical cell pool, a free logical cell pool is also available to the address selection circuit 1406 after initialization. Hence, the logical write address selection is performed for selecting logical write addresses associated with logical cells in the free logical cell pool. In this embodiment, the address selection circuit 1406 controls selection of the at least one logical write address according to at least one selection rule. For example, the at least one selection rule may specify that free logical cells should be used. When the logical write rule is also issued from the master device (e.g., QM circuit 104), the at least one selection rule used by the address selection circuit 1406 includes the received logical write rule for controlling selection of the at least one logical write address. The logical write rule may select pre-defined logical cells.

For example, in accordance with the logical write rule, cells of the same packet are written into different address locations, a cell with an SOP (start of packet)/EOP (end of packet) flag or an ENQ (enqueue) flag is stored at a corresponding pre-defined address location, a cell with a lossless flag or a lossy flag is stored at a corresponding pre-defined address location, a packet with a particular packet type (e.g., a packet with a guaranteed flag) is forced to be stored into a guaranteed buffer, a packet with another particular packet type (e.g., a packet with a non-guaranteed flag) is forced to be stored into a non-guaranteed buffer, the guaranteed buffer has a minimum guaranteed storage space for each ingress port, the accounting information of cells received from an ingress port and stored in a guaranteed buffer is checked, and/or information related to a packet or a cell is checked.

Similarly, the address selection circuit 1406 further generates a logical write response to the master device (e.g., QM circuit 104). For a lossy packet write operation, the logical write response may indicate that the logical write request has been dropped due to bank conflict of the multi-bank packet buffer. For a lossless packet write operation, the logical write response may indicate that bank conflict of the multi-bank packet buffer is about to happen in the multi-bank packet buffer. Hence, when being notified by the logical write response, the master device (e.g., QM circuit 104) may reduce its packet data output throughput to avoid the packet data drop.

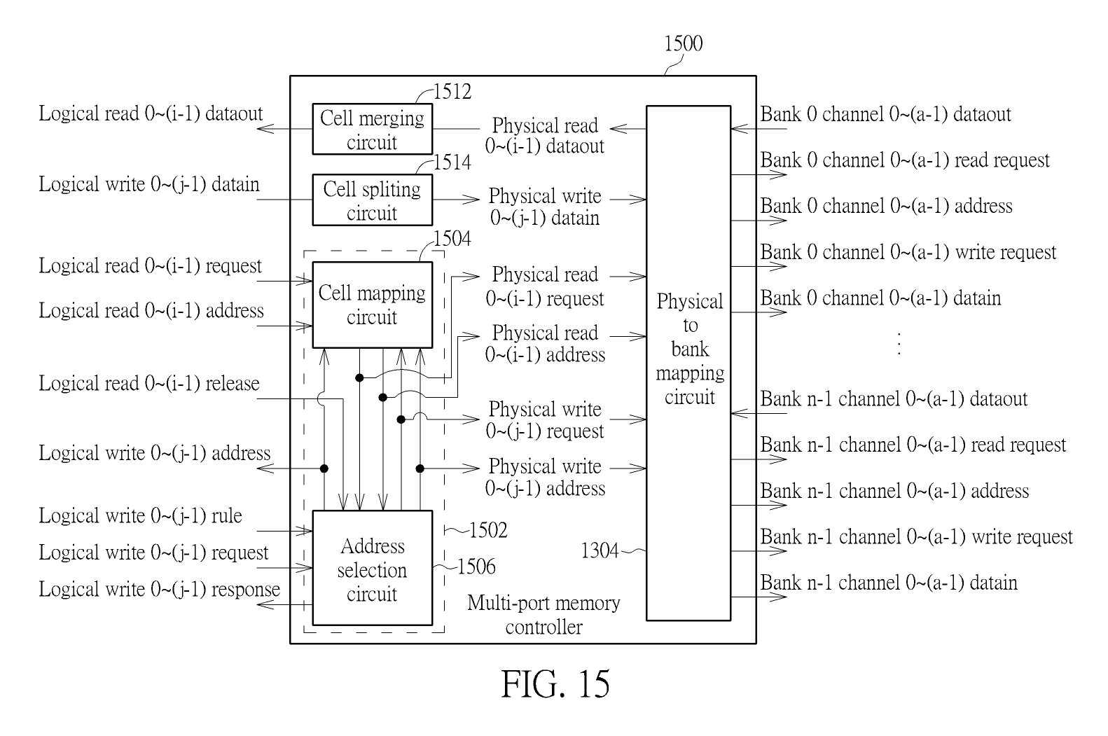

FIG. 15 is a diagram illustrating a third multi-port memory controller according to an embodiment of the present invention. The memory controller 108 maybe implemented using the multi-port memory controller 1500 shown in FIG. 15. In this embodiment, each large cell (e.g., logical cell) maybe further split into one or more small cells (e.g., physical cells). The major difference between the multi-port memory controllers 1400 and 1500 is that the multi-port memory controller 1500 further includes a cell merging circuit 1512 and a cell splitting circuit 1514. The cell splitting circuit 1514 is used to split one large cell (logical cell) to be written into the packet buffer into small cells (physical cells). The cell merging circuit 1512 is used to merge small cells (physical cells) read from the packet buffer into one large cell (logical cell).

The write address generation circuit 1502 includes a cell mapping circuit 1504 and an address selection circuit 1506. When storing write data into the packet buffer 110, the address selection circuit 1506 receives a logical write request of a packet from a master device (e.g., QM circuit 104), and generates at least one physical write address for at least one physical cell (e.g., small cell(s)) of the packet and at least one logical write address for at least one logical cell (e.g., large cell(s)) of the packet in response to at least the logical write request, and the cell mapping circuit 1504 records the mapping between the at least one logical write address (e.g., a single logical write address for a short packet, or multiple logical write addresses for a long packet) and the at least one physical write address (e.g., a single physical write address for a short packet, or multiple physical write addresses for a long packet) selected by the address selection circuit 1506. Next, the physical to bank mapping circuit 1304 maps the at least one physical write address to at least one memory bank 114 of the packet buffer 110.

The cell mapping circuit 1504 may map one logical cell address to m physical cell addresses, where m≧1. Alternatively, the logical cell address may be the physical cell address 0 to reduce the map memory size, where “physical cell address 0” means “address of the 1st physical cell in the m physical cells”. That is, when the logical cell address is the physical cell address 0, there is no need to record the address mapping between the logical cell and the 1st physical cell. In this way, the cell mapping circuit 1504 only needs to record that the logical cell address is mapped to (m−1) physical cell addresses.

Concerning the logical write address selection, the same selection rules employed by the address selection circuit 1406 may also be employed by the address selection circuit 1506. Further description is omitted here for brevity. Concerning the physical write address selection, the address selection circuit 1506 controls selection of the at least one physical write address according to at least one selection rule. In accordance with the at least one selection rule, a pre-defined cell space is selected for each small cell. For example, the m^{th} pre-defined cell space is selected for the m^{th} small cell (physical cell) included in one large cell (logical cell). When the logical write rule is also issued from the master device (e.g., QM circuit 104), the at least one selection rule used by the address selection circuit 1506 includes the logical write rule for controlling selection of the at least one physical write address. The logical write rule may select pre-defined cell spaces. For example, in accordance with the logical write rule, small cells (physical cells) of the same large cell (logical cell) are written into different address locations according to the physical cell number, and/or the small cells (physical cells) in the same large cell (logical cell) are selectively stored according to the associated valid cell flags.

Similarly, the address selection circuit 1506 further generates a logical write response to the master device (e.g., QM circuit 104). For a lossy packet write operation, the logical write response may indicate that the logical write request has been dropped due to bank conflict of the multi-bank packet buffer. For a lossless packet write operation, the logical write response may indicate that bank conflict of the multi-bank packet buffer is about to happen in the multi-bank packet buffer. Hence, when being notified by the logical write response, the master device (e.g., QM circuit 104) may reduce its packet data output throughput to avoid the packet data drop.

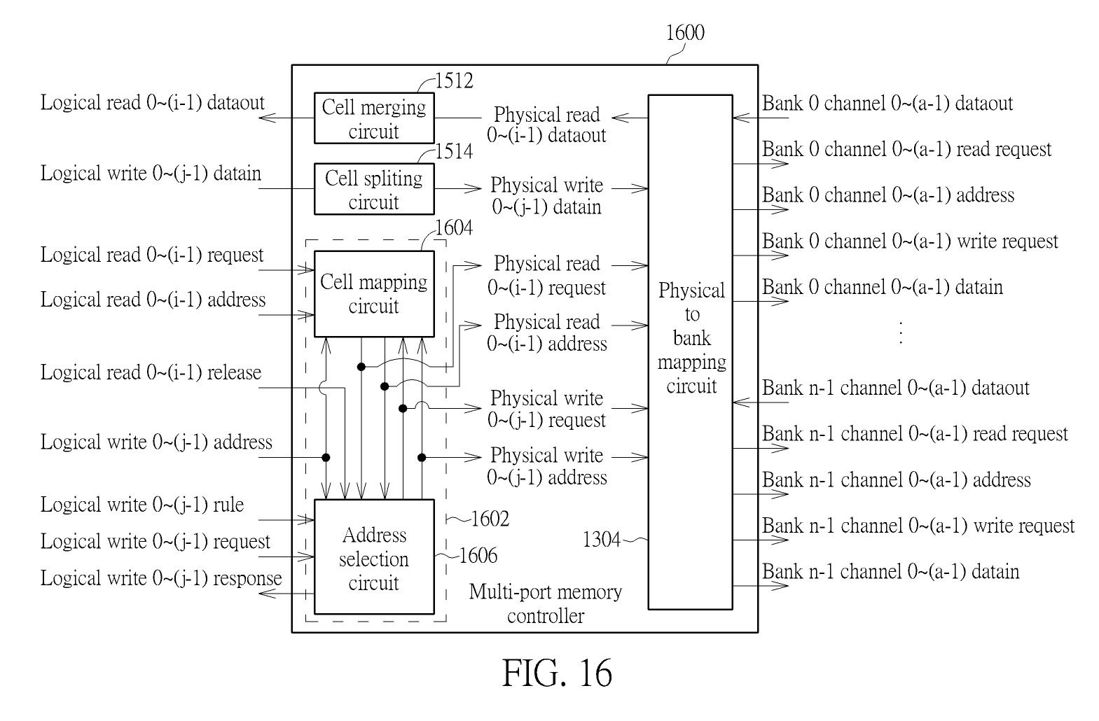

In above embodiments shown in FIGS. 13-15, no logical write address is issued from the master device (e.g., QM circuit 104) to the multi-port memory controllers 1300, 1400, 1500. In an alternative design, the multi-port memory controller may be modified to accept a logical write address issued from the master device (e.g., QM circuit 104), where the release of occupied cell spaces in the packet buffer 110 may be triggered by the master device (e.g., QM circuit 104). FIG. 16 is a diagram illustrating a fourth multi-port memory controller according to an embodiment of the present invention. The memory controller 108 maybe implemented using the multi-port memory controller 1600 shown in FIG. 16. The major difference between the multi-port memory controllers 1500 and 1600 is that the address selection circuit 1606 and the cell mapping circuit 1604 of the write address generation circuit 1602 may receive a logical write address issued from a master device (e.g., QM circuit 104). In this embodiment, the address selection circuit 1606 generates at least one physical write address for at least one cell (e.g., small cell (s)) of the packet in response to at least the logical write request and the logical write address. In this embodiment, when a logical write request of storing packet write data into the packet buffer 110 is issued from a master device (e.g., QM circuit 104), the address selection circuit 1306 releases previously used cell space(s) related to the logical write address and adds the released cell space(s) to the free physical cell pool, and then selects free cell space(s) from the free physical cell pool to determine the at least one physical write address in response to the logical write address. The cell mapping circuit 1604 records the mapping between the received logical write address and the at least one physical write address (e.g., a single physical write address for a short packet, or multiple physical write addresses for a long packet) determined by the address selection circuit 1606. Next, the physical to bank mapping circuit 1304 maps the at least one physical write address to at least one memory bank 114 of the packet buffer 110. In this embodiment, the logical write rule signal, the logical write response signal and/or the logical read release signal may be omitted.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A packet buffer for storing packet data of packets received by a master device, comprising:
a non-guaranteed buffer, wherein the non-guaranteed buffer is visible to the master device and is not guaranteed to provide one free cell space for one cell in a first-type packet before the non-guaranteed buffer is full;
a guaranteed buffer, wherein the guaranteed buffer is visible to the master device and is guaranteed to provide one free cell space for one cell in a second-type packet before the guaranteed buffer is full; and
a reserved buffer, wherein the reserved buffer is invisible to the master device and is arranged to provide headroom for the guaranteed buffer.

2. The packet buffer of claim 1, wherein when a packet has a flag set by a first value, the packet is classified as the first-type packet to be written into the non-guaranteed buffer; and when the packet has the flag set by a second value, the packet is classified as the second-type packet to be written into the guaranteed buffer.

3. The packet buffer of claim 2, wherein the flag is a packet type flag that indicates if the packet is a lossless packet, or a packet type flag that indicates if the packet is a control packet, or a buffer reservation flag that indicates if the packet is required to be stored into a reserved area in the guaranteed buffer.

4. A storage system for storing information associated with at least one packet, comprising:
a packet buffer, having a plurality of cell spaces, wherein each packet is split into at least one cell, each cell is stored into one cell space of the packet buffer, one cell group is transmitted in one transmission clock cycle, and said one cell group comprises multiple cells belonging to the at least one packet; and
a linked list buffer, arranged to store a linked list associated with packet data of the at least one packet stored in the packet buffer.

5. The storage system of claim 4, wherein the at least one packet includes a packet split into a plurality of cells, the cells comprise a first cell and a second cell that are not successive cells of the packet, and the linked list records that the first cell is linked to the second cell.

6. The storage system of claim 5, wherein the first cell and the second cell belong to different cell groups, respectively.

7. The storage system of claim 4, wherein the at least one packet includes a packet split into a plurality of cells, the cells comprise a first cell and a plurality of second cells, and the linked list records that the first cell is linked to the second cells.

8. A multi-port memory controller of a multi-bank packet buffer, comprising:
a write address generation circuit, arranged to receive a logical write request of a packet from a master device and generate at least one write address for at least one cell of the packet in response to at least the logical write request, wherein the multi-port memory controller is capable of serving multiple access requests by accessing different memory banks of the multi-bank packet buffer, and the write address generation circuit controls selection of the at least one write address according to at least one selection rule; and
a physical to bank mapping circuit, arranged to map at least one physical write address selected by the write address generation circuit to at least one bank of the multi-bank packet buffer.

9. The multi-port memory controller of claim 8, wherein no logical write address associated with the logical write request is issued from the master device and received by the multi-port memory controller.

10. The multi-port memory controller of claim 8, wherein the write address generation circuit is further arranged to generate a logical write address associated with the logical write request to the master device.

11. The multi-port memory controller of claim 8, wherein in accordance with the at least one selection rule, cells of a same packet are written into different memory banks per clock cycle.

12. The multi-port memory controller of claim 8, wherein in accordance with the at least one selection rule, access of each memory bank does not exceed maximum throughput of the memory bank.

13. The multi-port memory controller of claim 8, wherein in accordance with the at least one selection rule, the at least one write address is set according to at least one free cell selected from a free cell pool.

14. The multi-port memory controller of claim 8, wherein the write address generation circuit is further arranged to receive a logical write rule from the master device, and the at least one selection rule used by the write address generation circuit comprises the received logical write rule.

15. The multi-port memory controller of claim 14, wherein in accordance with the received logical write rule, the selection of the at least one write address is constrained to at least one pre-defined address.

16. The multi-port memory controller of claim 15, wherein in accordance with the received logical write rule, cells of a same packet are written into different pre-defined addresses.

17. The multi-port memory controller of claim 15, wherein in accordance with the received logical write rule, a cell with an SOP (start of packet) flag, an EOP (end of packet) flag or an ENQ (enqueue) flag is stored at a corresponding pre-defined address.

18. The multi-port memory controller of claim 15, wherein in accordance with the received logical write rule, a cell with a lossless flag or a lossy flag is stored at a corresponding pre-defined address.

19. The multi-port memory controller of claim 15, wherein in accordance with the received logical write rule, a packet with a guaranteed flag is forced to be stored into a guaranteed buffer, and a packet with a non-guaranteed flag is forced to be stored into a non-guaranteed buffer.

20. The multi-port memory controller of claim 8, wherein the write address generation circuit is further arranged to generate a logical write response to the master device, and the logical write response indicates that the logical write request has been dropped due to bank conflict of the multi-bank packet buffer or indicates that bank conflict of the multi-bank packet buffer is about to happen in the multi-bank packet buffer.
